(19) United States
(12) Patent Application Publication
(10) Pub. No.: US 2018/0134369 A1
(43) Pub. Date: May 17, 2018

(54) Arm linkage foldable device for UAV and UAV having the same

(71) Applicant: Haoxiang Electric Energy (Kunshan)Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/854,773

(22) Filed: Dec. 27, 2017

(30) Foreign Application Priority Data
Dec. 29, 2016 (CN) 201621469931.7

(51) Int. Cl. B64C 1/30; B64C 39/02

(52) U.S. Cl. CPC B64C 1/30; B64C 39/024; B64C 2201/102; B64C 2201/108; B64C 2201/027

(57) ABSTRACT

An arm linkage foldable device for a UAV (unmanned aerial vehicle) includes a linkage module and two connection modules. The linkage module includes a guided structure and a slider. The slider slides along the guided structure. Two aircraft arms located at two sides of the fuselage are respectively connected with two sides of a slider through the two connection modules, a joint of every connection module and the slider is rotatable. A protruding portion is located on every connection module, a slide groove is provided on the fuselage corresponding to the protruding portion, the protruding portion is inserted into the slide groove and slides along the slide groove. The slider moves along the guided structure to drive one connection module to move, the connection module drives one aircraft arm to move with the slider and rotate relatively to the slider, so that the aircraft is unfolded or folded.

### CROSS REFERENCE OF RELATED APPLICATION

The present invention claims priority under 35 U.S.C. 119(a-d) to CN 201621469931.7, filed Dec. 29, 2016.

### BACKGROUND OF THE PRESENT INVENTION

### Field of Invention

The present invention relates to a technical field of UAV (unmanned aerial vehicle), and more particularly to an arm linkage foldable device for a UAV and a UAV having the same.

### Description of Related Arts

Due to flexibility, rapid response, unmanned flight and low operational requirement, UAVs are widely used in agriculture, exploration, photography, border patrols and other fields. There are a variety of UAVs, each of which usually comprises a fuselage and two aircraft arms located at both sides of the fuselage. Some of the aircraft arms of these UAVs are fixed directly on the fuselage and unable to be folded, and some are foldable for portability and are folded when the aircraft arms are not in use.

However, the aircraft arms of these UAVs are independent from each other and need to be manually folded one by one when folded, which brings inconvenience to users.

### SUMMARY OF THE PRESENT INVENTION

To solve the problem of the prior art that the aircraft arms of the UAV need to be folded one by one, the present invention provides an arm linkage foldable device for a UAV (unmanned aerial vehicle), which is configured to be located at a fuselage of the UAV and connected with two aircraft arms symmetrically located at the fuselage, wherein the arm linkage foldable device comprises:

a linkage module, which comprises a guided structure configured to be installed on the fuselage and a slider installed on the guided structure, wherein the slider is able to slide along the guided structure; and

two connection modules configured to respectively connect the two aircraft arms at two sides of the fuselage with two sides of the slider, wherein a joint of every connection module and the slider is rotatable, a protruding portion is located on every connection module, a slide groove is configured to be provided on the fuselage and is corresponding to the protruding portion, the protruding portion inserts into the slide groove and slides along the slide groove;

wherein the slider moves along the guided structure to drive a corresponding connection module to move along the slide groove, and simultaneously the corresponding connection module rotates relatively to the slider and is configured to drive a corresponding aircraft arm to move with the slider and rotate relatively to the slider.

Preferably, the guided structure is a guided rod, and the slider is sleeved on the guided rod and axially moves along the guided rod.

Preferably, the slide groove is arched.

Preferably, every connection module is arched, one end of every connection module is configured to be connected with one aircraft arm, and every connection module is rotatably connected with the slider through a pin.

Preferably, the other end of every connection module has a slot, two extension portions are respectively located at two sides of the slider, the extension portions are respectively inserted into the slots, and every connection module is connected with the slider through the pin.

Preferably, a first buckling component is located at an upper surface of the slider, and a second buckling component is configured to be located on the fuselage above the slider and is corresponding to the first buckling component, such that when the slider slides till the aircraft arms are unfolded, the first buckling component is buckled with the second buckling component.

The present invention also provides a UAV (unmanned aerial vehicle), comprising the arm linkage foldable device mentioned above.

Through the technical solutions mentioned above, compared with the prior art, the present invention has beneficially effects as follows.

In the arm linkage foldable device for the UAV and the UAV provided by the present invention, two aircraft arms at two sides of the fuselage are respectively connected with two sides of the slider through two connection modules, so that the linkage function of two aircraft arms is achieved. When one aircraft arm at one side of the fuselage is folded or unfolded, the slider is driven to slide so as to further drive the other aircraft arm at the other side of the fuselage to be folded or unfolded, which simplifies the operational steps and is more convenient in use.

### BRIEF DESCRIPTION OF THE DRAWINGS

The above-mentioned and other features and advantages of the present invention will be more clearly understood from the following detailed description with the accompanying drawings.

FIG. 1 is an exploded view of a UAV (unmanned aerial vehicle) of the present invention.

FIG. 2 is a sectional view of the UAV of the present invention.

FIG. 3 is a structurally schematic view of the UAV whose aircraft arms are unfolded of the present invention.

FIG. 4 is a structurally schematic view of the UAV whose aircraft arms are folded of the present invention.

### DETAILED DESCRIPTION OF THE PREFERRED EMBODIMENT

The present invention is further described in detail with accompanying drawings as follows. However, the present invention may be embodied in many different forms and should not be construed as being limited by the embodiments set forth herein. On the contrary, these embodiments are presented so as to achieve thorough and complete disclosure, and to enable any person skilled in the art to fully understand the scope of the present invention. In the drawings, sizes and relative sizes of layers and regions may be exaggerated for clarity.

### First Embodiment

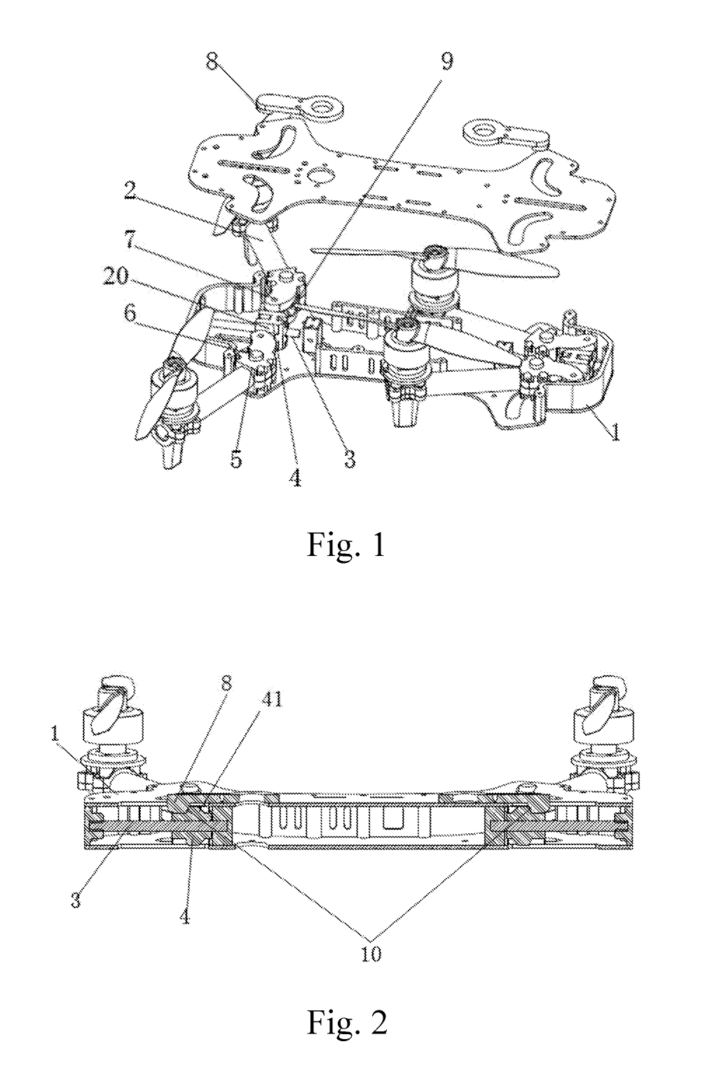

Referring to FIGS. 1 and 2, the present invention provides an arm linkage foldable device for a UAV (unmanned aerial vehicle), which is located at a fuselage 1 of the UAV and connected with two aircraft arms 2 symmetrically located at the fuselage 1. The arm linkage foldable device comprises a linkage module 20 and two connection modules 5, wherein the linkage module 20 comprises a guided structure 21 installed on the fuselage 1 and a slider 4 installed on the guided structure 21, the slider 4 is able to slide along the guided structure 21; two aircraft arms 2 located at two sides of the fuselage 1 are respectively connected with two sides of the slider 4 through the two connection modules 5, a joint of every connection module 5 and the slider 4 is rotatable; a protruding portion 6 is located on every connection module 5, a slide groove 11 is provided on the fuselage 1 corresponding to the protruding portion 6, and the protruding portion 6 is inserted into the slide groove 11 and slides along the slide groove 11.

The slider 4 moves along the guided structure to drive one connection module 5 to move along a direction that the protruding portion 6 moves in the slide groove 11, and simultaneously the connection module 5 rotates relatively to the slider 4; and due to the connection between the aircraft arms 2 with the connection modules 5, the connection modules 5 drive the aircraft arms to move with the slider 4 and rotate relatively to the slider 4, so that the aircraft arms 2 are unfolded or folded during the move and rotation process thereof.

In the present invention, the aircraft arms 2 located at two sides of the fuselage 1 are respectively connected with the slider through the connection modules 5 respectively, so that the linkage function between the aircraft arms at the two sides of the fuselage is achieved. When one aircraft arm located at one side of the fuselage is unfolded or folded, the slider is driven to slide, so as to further drive another aircraft arm located at the other side of the fuselage to be unfolded and folded, which simplifies the operational steps and is convenient in use.

In the first embodiment, the slide groove 11 is preferably arched.

In the first embodiment, the arm linkage foldable device is applied to a UAV with four aircraft arms to be illustrated, wherein two aircraft arms located at two sides of a front end of the fuselage share an arm linkage foldable device, two aircraft arms located at two sides of a rear end of the fuselage share an arm linkage foldable device. Of course, the present invention is not only adapted for the UAVs shown in FIGS. 1 and 2, but also for other UAVs, which is not limited here.

In the first embodiment, the guided structure is a guided rod 3, two ends of the guided rod 3 are fixed in the fuselage 1; the slider 4 has a slide hole, is sleeved on the guided rod 3 through the slide hole and is able to slide relatively to the guided rod 3. Of course, in other embodiments, the guided structure is able to be a guide rail or other structures, which is not limited here.

In the first embodiment, every connection module 5 is arched, one end of every connection module 5 is fixedly connected with one aircraft arm 2, and every connection module 5 is rotatably connected with the slider 4 through a pin 7. Specifically, the other end of the connection module 5 has a slot 9, two extension portions 41 are respectively located at two sides of the slider 4 and respectively inserted into the slots 9, and every connection module 5 is connected with the slider 4 through the pin 7. Of course, the rotation connection between the connection modules and the slider 4 in other embodiments is able to be achieved through hinges or other manners, which is not limited here.

In the first embodiment, a first buckling component 10 is located at an upper surface of the slider 4, a second buckling component 8 which is corresponding to the first buckling component 10 is located on the fuselage 1 above the slider 4; when the slider 4 slides till the aircraft arms are unfolded, the first buckling component 10 is buckled with the second buckling component 8 for fixing with the slider 4; the slider 4 is unable to slide without being applied an external force, so that the aircraft arm 1 will not rotate freely after being unfolded, which is convenient for the normal use of the UAV.

In the first embodiment, the second buckling component 8 is located on a fastener which is fixed to an upper end of the fuselage. Of course, in other embodiments, the second buckling component 8 is able to be directly located at a bottom of an interior of the fuselage, which are able to be made as a whole. There is no restriction here.

The working process of the arm linkage foldable device of the UAV provided by the present invention is explained as follows.

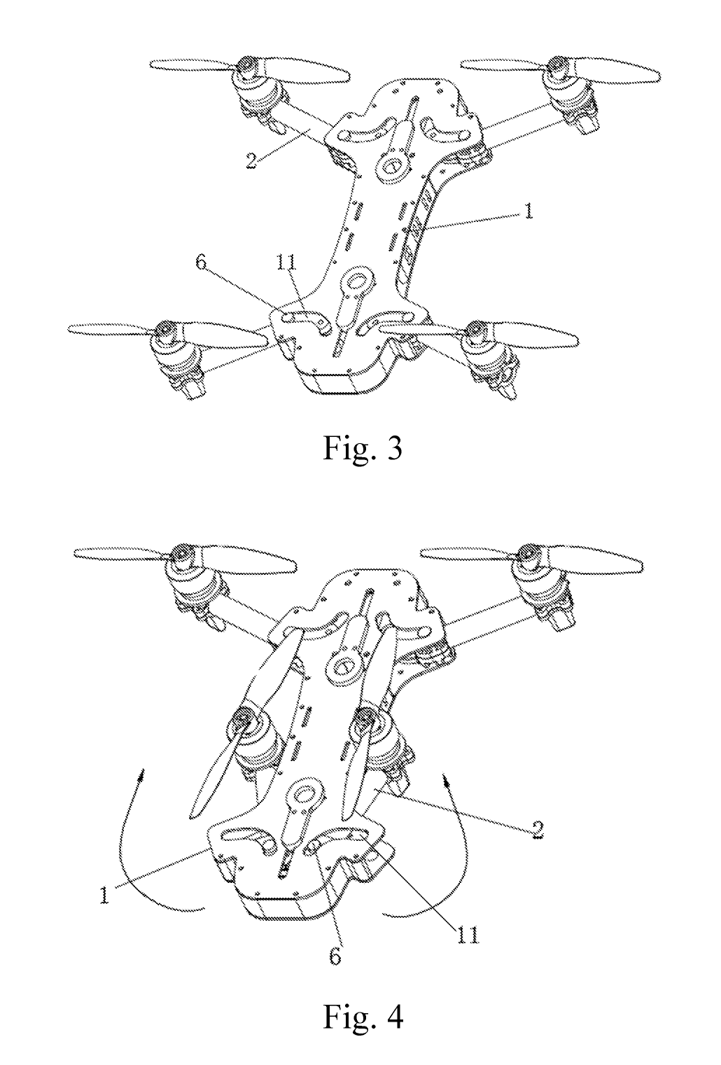

Referring to FIGS. 2 and 3, the aircraft arms 1 are unfolded, the slider 4 is located at a right end of the guided rod 3, the first buckling component 10 is buckled with the second buckling component 8, the slider 4 is locked; a certain force is applied to one aircraft arm located at one side of the fuselage, the first buckling component 10 is detached from the second buckling component 8 to rotate the aircraft arm, so as to allow the protruding portion 6 located on the connection module 5 to slide along the slide groove 11; when the aircraft arm located at one side of the fuselage is folded, the slider 4 is driven to move towards a left end of the guided rod 3, so as to further drive the other aircraft arm located at the other side of the fuselage to move and rotate for being folded, as shown in FIG. 4.

### Second Embodiment

The present invention also provides a UAV (unmanned aerial vehicle), which comprises a fuselage 1, two pairs of aircraft arms 2 located at a front end and a rear end of the fuselage 1, wherein every pair of aircraft arms comprises two aircraft arms symmetrically located at two sides of the fuselage 1 and is installed to the fuselage 1 through the arm linkage foldable device provided by the first embodiment, which is not explained again here.

It will be understood by those skilled in the art that the present invention may be embodied in many other specific forms without departing from the spirit or scope of the present invention. Although the embodiments of the present invention have been described, it should be understood that the present invention should not be limited to these embodiments, and variations and modifications may be made by those skilled in the art within the spirit and scope of the present invention as defined by the appended claims.

What is claimed is:

1. An arm linkage foldable device for a UAV (unmanned aerial vehicle), which is configured to be located at a fuselage of the UAV and connected with two aircraft arms symmetrically located at the fuselage, wherein the arm linkage foldable device comprises:
a linkage module, which comprises a guided structure configured to be installed on the fuselage and a slider installed on the guided structure, wherein the slider is able to slide along the guided structure; and
two connection modules configured to respectively connect the two aircraft arms at two sides of the fuselage with two sides of the slider, wherein a joint of every to connection module and the slider is rotatable, a protruding portion is located on every connection module, a slide groove is configured to be provided on the fuselage and is corresponding to the protruding portion, the protruding portion inserts into the slide groove and slides along the slide groove;
wherein the slider moves along the guided structure to drive a corresponding connection module to move along the slide groove, and simultaneously the corresponding connection module rotates relatively to the slider and is configured to drive a corresponding aircraft arm to move with the slider and rotate relatively to the slider.

2. The arm linkage foldable device for the UAV, as recited in claim 1, wherein the guided structure is a guided rod, the slider is sleeved on the guided rod and axially moves along the guided rod.

3. The arm linkage foldable device for the UAV, as recited in claim 1, wherein the slide groove is arched.

4. The arm linkage foldable device for the UAV, as recited in claim 1, wherein every connection module is arched, one end of every connection module is configured to be fixedly connected with one aircraft arm, every connection module is rotatably connected with the slider through a pin.

5. The arm linkage foldable device for the UAV, as recited in claim 4, wherein the other end of every connection module has a slot, two extension portions are respectively located at two sides of the slider, the extension portions are respectively inserted into the slots, every connection module is connected with the slider through the pin.

6. The arm linkage foldable device for the UAV, as recited in claim 1, wherein a first buckling component is located at an upper surface of the slider, a second buckling component is configured to be located on the fuselage above the slider and is corresponding to the first buckling component, such that when the slider slides till the aircraft arms are unfolded, the first buckling component is buckled with the second buckling component.
